(19) United States
(12) Patent Application Publication
(10) Pub. No.: US 2026/0190133 A1
(43) Pub. Date: Jul. 2, 2026

(54) METHOD AND APPARATUS FOR TRANSMITTING INTERFERENCE OFFSET INFORMATION, AND READABLE STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/864,361

(22) PCT Filed: May 11, 2022
(86) PCT No.: PCT/CN2022/092288

§ 371 Date: Nov. 8, 2024

(51) Int. Cl. H04W 72/541; H04W 72/0453

(52) U.S. Cl. CPC H04W 72/541; H04W 72/0453

(57) ABSTRACT

A method for transmitting interference offset information, includes: transmitting minimum offset information to a network device, where the minimum offset information is used to indicate a minimum offset between a center frequency point of an uplink interference signal and a center frequency point of an interfered signal in multicarrier transmission.

### CROSS REFERENCE TO RELATED APPLICATIONS

The application is a U.S. National Stage of International Application No. PCT/CN2022/092288, filed on May 11, 2022, the contents of all of which are incorporated herein by reference in their entireties for all purposes.

### BACKGROUND OF THE INVENTION

In some wireless communication systems, such as 4G or 5G communication systems, the multicarrier technology is used to improve a transmission rate and a system capacity.

### SUMMARY OF THE INVENTION

The disclosure provides a method and apparatus for transmitting interference offset information, and a readable storage medium.

In a first aspect, a method for transmitting interference offset information is provided. The method is performed by a user device and includes: transmitting minimum offset information to a network device. The minimum offset information is used to indicate a minimum offset between a center frequency point of an uplink interference signal and a center frequency point of an interfered signal during multicarrier transmission.

In a second aspect, a method for transmitting interference offset information is provided. The method is performed by a network device and includes: receiving minimum offset information transmitted by a user device. The minimum offset information is used to indicate a minimum offset between a center frequency point of an uplink interference signal and a center frequency point of an interfered signal during multicarrier transmission.

In a third aspect, a communication apparatus is provided. The communication apparatus includes a processor and a memory. The memory is used to store a computer program. The processor is used to execute the computer program, so as to implement the first aspect or any one of possible designs of the first aspect.

In a fourth aspect, a communication apparatus is provided. The communication apparatus includes a processor and a memory. The memory is used to store a computer program. The processor is used to execute the computer program, so as to implement the second aspect or any one of possible designs of the second aspect.

In a fifth aspect, a non-transitory computer-readable storage medium is provided. The computer-readable storage medium stores an instruction (or referred to as a computer program or a program). When the instruction is called to be executed on a computer, the computer is caused to execute the first aspect or any one of possible designs of the first aspect.

In a sixth aspect, a non-transitory computer-readable storage medium is provided. The computer-readable storage medium stores an instruction (or referred to as a computer program or a program). When the instruction is called to be executed on a computer, the computer is caused to execute the second aspect or any one of possible designs of the second aspect.

It should be understood that the general descriptions and the following detailed descriptions are illustrative and explanatory merely, and cannot limit the disclosure.

### BRIEF DESCRIPTION OF DRAWINGS

Accompanying drawings described here serve as a constituent part of the disclosure to provide a further understanding of examples of the disclosure. The examples of the disclosure and their descriptions serve to explain the examples of the disclosure, and are not to be construed as unduly limiting the examples of the disclosure. The accompanying drawings here are incorporated into the description as a constituent part of the description, illustrate examples conforming to examples of the disclosure, and serve to explain principles of the examples of the disclosure along with the description.

FIG. 1 is a schematic diagram of an architecture of a wireless communication system according to an example of the disclosure.

FIG. 2 is a schematic flow diagram of a method for transmitting interference offset information according to an example.

FIG. 3 is a schematic flow diagram of another method for transmitting interference offset information according to an example.

FIG. 4 is a flow diagram of a method for transmitting interference offset information according to an example.

FIG. 5 is a schematic diagram of a minimum offset according to an example.

FIG. 6 is a flow diagram of a method for transmitting interference offset information according to an example.

FIG. 7 is a flow diagram of a method for transmitting interference offset information according to an example.

FIG. 8 is a flow diagram of a method for transmitting interference offset information according to an example.

FIG. 9 is a schematic diagram of resource configuration information according to an example.

FIG. 10 is a structural diagram of an apparatus for transmitting interference offset information according to an example.

FIG. 11 is a structural diagram of another apparatus for transmitting interference offset information according to an example.

FIG. 12 is a structural diagram of yet another apparatus for transmitting interference offset information according to an example.

FIG. 13 is a structural diagram of still another apparatus for transmitting an interference offset information according to an example.

### DETAILED DESCRIPTION OF THE INVENTION

Examples of the disclosure will be further described in combination with accompanying drawings and particular embodiments.

Examples will be described in detail here and shown in accompanying drawings illustratively. When the following descriptions involve accompanying drawings, unless otherwise specified, the identical number in different accompanying drawings denotes the identical or similar elements. The embodiments described in the following examples do not denote all embodiments consistent with examples of the disclosure. On the contrary, the embodiments are merely instances of apparatuses and methods consistent with some aspects of the disclosure as detailed in the appended claims.

Terms used in examples of the disclosure are merely used to describe particular examples, and are not intended to limit examples of the disclosure. Singular forms such as “a/an” and “the” used in examples of the disclosure and the appended claims are also intended to include plural forms, unless otherwise clearly stated in the context. It should also be understood that the term “and/or” used here refers to and includes any or all possible combinations of one or more of associated listed items.

It should be understood that although terms such as first, second and third may be used in examples of the disclosure to describe various types of information, such information should not be limited to these terms. These terms are merely used to distinguish the same type of information from each other. For instance, first information can also be referred to as second information, and similarly, second information can also be referred to as first information, without departing from the scope of examples of the disclosure. Depending on the context, the word “if” as used here may be interpreted as “in a case of”, “in a case that” or “in response to determining”.

Examples of the disclosure will be described in detail below. Instances of the examples are shown in accompanying drawings, throughout which identical or similar reference numerals denote identical or similar elements. Examples described below with reference to accompanying drawings are illustrative and are intended to explain the disclosure, but cannot be construed as a limitation on the disclosure.

Potential self-interference problems are discovered during multicarrier transmission in some frequency band combinations.

In a case that a frequency band is determined, magnitude of self-interference is generally related to uplink transmitting power. The greater the transmitting power, the greater the self-interference, and the greater the downlink sensitivity degradation.

In order to ensure the performance of carrier aggregation, sensitivity degradation in a worst case is generally specified, such as maximum sensitivity degradation (MSD). For instance, minimum MSD requirements of different frequency band combinations are defined in 3rd generation partnership project (3GPP) 101 series standards.

The MSD of some frequency band combinations may exceed 30 dB. When these frequency band combinations are deployed by an operator, a method of completely not allowing terminals in a cell to be configured with multicarrier modes is adoptable. As a result, some terminals that can be configured with multicarrier modes cannot be configured with multicarrier modes (for instance, some terminals excellent in MSD performance or terminals located in the center of the cell suffer less actual sensitivity degradation due to lower transmitting power, thus it is impossible to use the multicarrier technology to improve the rate and the system capacity). A method of allowing the multicarrier modes to be configured is also adoptable. However, when some terminals suffering great sensitivity degradation work in multicarrier modes, system performance degradation will also be caused.

Thus, how to reduce self-interference in a multicarrier mode is a technical problem to be solved. In the technical field of wireless communication, the disclosure provides a method and apparatus for transmitting interference offset information, and a readable storage medium.

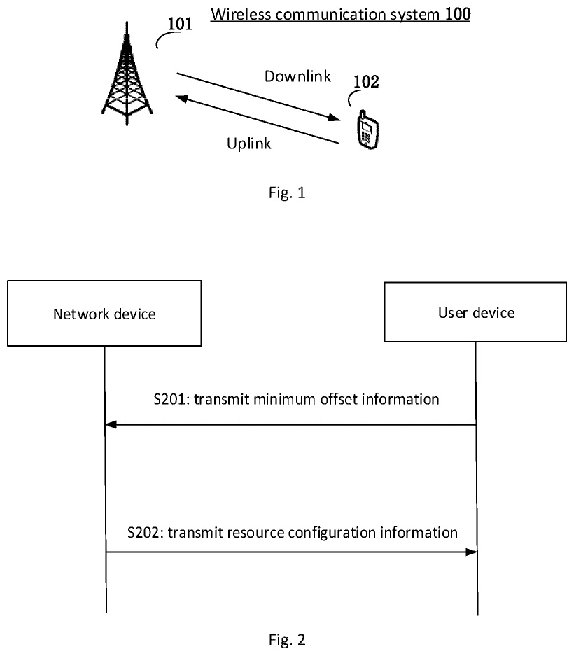

As shown in FIG. 1, a method for transmitting interference offset information provided in an example of the disclosure may be performed by a wireless communication system 100. The wireless communication system 100 may include but is not limited to a network device 101 and a user device 102. The user device 102 is configured to support carrier aggregation. The user device 102 may be connected to a plurality of carrier units of the network device 101 which include one primary carrier unit and one or more secondary carrier units.

It should be understood that the wireless communication system 100 may be applicable to both a low-frequency scenario and a high-frequency scenario. Application scenarios of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, or a future evolved public land mobile network (PLMN) system, etc.

The user device 102 may be user equipment (UE), a terminal, an access terminal, a terminal unit, a terminal station, a mobile station (MS), a remote station, a remote terminal, a mobile terminal, a wireless communication device, a terminal proxy, or a user device, etc. The user device 102 may have a wireless transceiver function, may be in communication (such as wireless communication) with one or more network devices 101 of one or more communication systems, and may receive a network service provided by the network device 101. The network device 101 here includes but is not limited to a base station shown in FIG. 1.

The user device 102 may be a cellular telephone, a cordless telephone, a session initiation protocol (SIP) telephone, a wireless local loop (WLL) station, a personal digital assistant (PDA) device, a handheld device having a wireless communication function, a computing device or other processing devices connected to a wireless modem, an in-vehicle device, a wearable device, a user device in a future 5G network, a user device in a future evolved PLMN network, etc.

The network device 101 may be an access network device (or referred to as an access network site). The access network device refers to a device that provides a network access function, such as a radio access network (RAN) base station. The network device 101 may specifically include a base station (BS), or include a base station and a radio resource management device used to control a base station. The network device 101 may further include a relay station (a relay device), an access point, a base station in a future 5G network, a base station in a future evolved PLMN network, a NR base station, etc. The network device 101 may be a wearable device or an in-vehicle device. The network device 101 may also be a communication chip having a communication module.

For instance, the network device 101 includes but is not limited to a gnodeB (gNB) in 5G, an evolved node B (eNB) in an LTE system, a radio network controller (RNC), a node B (NB) in a wideband code division multiple access (WCDMA) system, a radio controller in a CRAN system, a base station controller (BSC), a base transceiver station (BTS) in a global system for mobile communications (GSM) system or a code division multiple access (CDMA) system, a home base station (such as a home evolved node B or a home node B (HNB)), a baseband unit (BBU), a transmitting and receiving point (TRP), a transmitting point (TP), or a mobile switching center, etc.

In order to ensure the performance of carrier aggregation, it is generally stipulated that maximum sensitivity degradation (MSD) in the worst case cannot exceed a certain value. For instance, the minimum MSD requirements of different frequency band combinations are defined in 3rd generation partnership project (3GPP) 101 series standards. The MSD of some frequency band combinations may exceed 30 dB. As a result, a downlink may be completely interfered and cannot work. The so-called worst case mentioned means that a center frequency point of an uplink interference signal generated by a configured resource block is just aligned with a center frequency point of an interfered receiving channel.

Considering that this case is rare in an actual network because the configured resource block is determined according to channel quality, if there is an offset between the center frequency point of the uplink interference signal and the center frequency point of the affected receiving channel, actual sensitivity degradation will be less than the MSD such that an influence brought by self-interference can be greatly reduced. In order to consider the offset, a plurality of examples are provided in the disclosure and specifically described below.

The multicarrier transmission in the disclosure may be carrier aggregation transmission or dual connection transmission. For instance, dual connection is EUTRA-NR dual connection (EN-DC).

An example of the disclosure provides a method for transmitting interference offset information. FIG. 2 is a flow diagram of a method for transmitting interference offset information according to an example. As shown in FIG. 2, the method includes S201 and S202.

S201: a user device transmits minimum offset information to a network device.

The minimum offset information is used to indicate a minimum offset between a center frequency point of an uplink interference signal and a center frequency point of an interfered signal during multicarrier transmission.

In some possible embodiments, the minimum offset is a minimum offset bandwidth, or the minimum offset is a number of resource blocks corresponding to a minimum offset bandwidth.

In an instance, in a case that the minimum offset is the minimum offset bandwidth, the minimum offset is 20 MHz.

In an instance, minimum offsets may be different in different multicarrier configurations. For instance, in a case that Band X and band Y serve as a multicarrier combination, the reported minimum offset is 20 MHz. In a case that Band X and Band Z serve as a multicarrier combination, the reported minimum offset is 25 MHz.

In an instance, the minimum offset is a number of resource blocks corresponding to a minimum offset bandwidth. For instance, a number of resource blocks (RBs) corresponding to a subcarrier having a minimum offset bandwidth of 15 kHz is 100.

S202: the network device transmits resource configuration information to the user device based on the received minimum offset information.

An offset between a first center frequency point and a second center frequency point corresponding to an uplink configuration resource indicated by the resource configuration information is greater than the minimum offset. The first center frequency point is a center frequency point of a potential uplink interference signal corresponding to the uplink configuration resource. The second center frequency point is a center frequency point of a downlink interfered signal of the potential uplink interference signal.

In an example of the disclosure, the user device transmits minimum offset information indicating a minimum offset between a center frequency point of an uplink interference signal and a center frequency point of an interfered signal during multicarrier transmission to the network device. The network device can determine more reasonable resource configuration information according to the received minimum offset information, and configure, for the user device, an uplink configuration resource capable of preventing self-interference such that self-interference during multicarrier transmission can be reduced and a performance of the multicarrier transmission can be improved.

In an example of the disclosure, the user device may actively report the minimum offset information, for instance, regularly or periodically report the minimum offset information, without transmitting a reporting notification message by the network device.

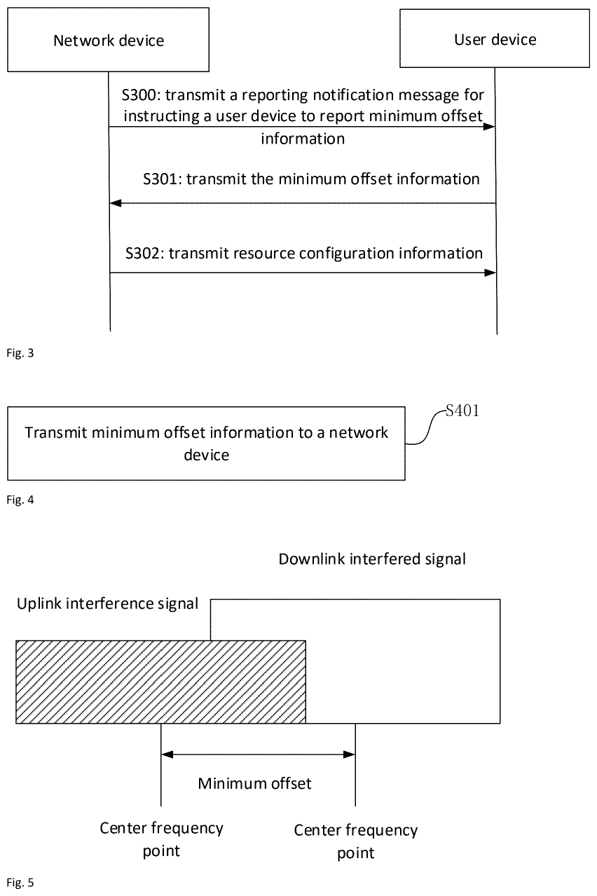

An example of the disclosure provides a method for transmitting interference offset information. FIG. 3 is a flow diagram of a method for transmitting interference offset information according to an example. As shown in FIG. 3, the method includes steps S300-S302.

S300: the network device transmits, to the user device, a reporting notification message for instructing the user device to report the minimum offset information.

Moreover, the method includes S301 and S302. Specifically, S301 and S302 are the same as S201 and S202, and the descriptions are not repeated.

In an example of the disclosure, the user device reports the minimum offset information after receiving the reporting notification message of the network device, and cannot actively report the minimum offset information. Certainly, the user device may also report the minimum offset information based on other triggering conditions. For instance, the user device may report the minimum offset information based on a triggering condition determined by a communication protocol; the user device may regularly or periodically report the minimum offset information; or the user device may report the minimum offset information based on pre-stored configuration information. Various triggering conditions may exist and will not be repeated here.

An example of the disclosure provides a method for transmitting interference offset information. The method is performed by a user device. FIG. 4 is a flow diagram of a method for transmitting interference offset information according to an example. As shown in FIG. 4, the method includes step S401.

S401: Minimum offset information is transmitted to a network device. The minimum offset information is used to indicate a minimum offset between a center frequency point of an uplink interference signal and a center frequency point of an interfered signal during multicarrier transmission.

FIG. 5 shows a schematic diagram of minimum offset information.

In some possible embodiments, the minimum offset is a minimum offset bandwidth, or the minimum offset is a number of resource blocks corresponding to a minimum offset bandwidth.

In an instance, the minimum offset is the minimum offset bandwidth. For instance, the minimum offset is 20 MHz.

In an instance, minimum offsets may be different in different multicarrier configurations. For instance, in a case that Band X and band Y serve as multicarrier aggregation, the reported minimum offset is 20 MHz. In a case that Band X and Band Z serve as multicarrier aggregation, the reported minimum offset is 25 MHz.

In an instance, the minimum offset is a number of resource blocks corresponding to a minimum offset bandwidth. For instance, a number of resource blocks (RBs) corresponding to a subcarrier having a minimum offset bandwidth of 15 kHz is 100.

In some possible embodiments, the minimum offset information includes a minimum offset corresponding to at least one self-interference type.

In an instance, in a case that various interference types of potential self-interference exist in a certain multicarrier configuration, it is required to give offsets of different interference types in forms of indexes, so as to transmit the minimum offset information, which is shown in Table 1 for instance.

TABLE 1

| | | Minimum |
|---|---|---|
| | | offset |
| Indication | Interference type | (MHz) |
| 1 | Adjacent channel interference | 50 |
| 2 | Harmonic interference | 25 |
| 3 | Second-order intermodulation | 20 |
| | interference | |

An example of the disclosure provides a method for transmitting interference offset information. The method is performed by a user device. FIG. 6 is a flow diagram of a method for transmitting interference offset information according to an example. As shown in FIG. 6, the method includes steps S601-S602.

S602: minimum offset information is transmitted to a network device. The minimum offset information is used to indicate a minimum offset between a center frequency point of an uplink interference signal and a center frequency point of an interfered signal during multicarrier transmission.

Specifically, S602 is the same as S401 described herein and will not be described again.

In some possible embodiments, the method further includes S603 that resource configuration information transmitted by the network device is received. An offset between a first center frequency point and a second center frequency point corresponding to an uplink configuration resource indicated by the resource configuration information is greater than the minimum offset. The first center frequency point is a center frequency point of a potential uplink interference signal corresponding to the uplink configuration resource. The second center frequency point is a center frequency point of a downlink interfered signal of the potential uplink interference signal.

In some possible embodiments, the method further includes S601that a reporting notification message transmitted by the network device is received. The reporting notification message is used to instruct the reporting of the minimum offset information.

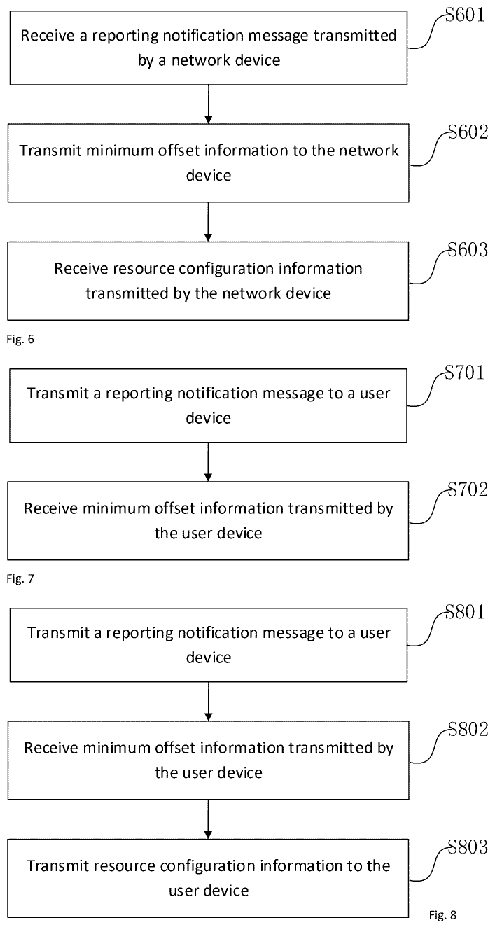

An example of the disclosure provides a method for transmitting interference offset information. The method is performed by a network device. FIG. 7 is a flow diagram of a method for transmitting interference offset information according to an example. As shown in FIG. 7, the method includes steps S701-S702.

S702: minimum offset information transmitted by a user device is received. The minimum offset information is used to indicate a minimum offset between a center frequency point of an uplink interference signal and a center frequency point of an interfered signal during multicarrier transmission.

Specifically, S702 corresponds to S401 described herein, and will not be described again.

The method further includes S701 that a reporting notification message is transmitted to the user device. The reporting notification message is used to instruct the user device to report the minimum offset information.

An example of the disclosure provides a method for transmitting interference offset information, which is performed by a network device. FIG. 8 is a flow diagram of a method for transmitting interference offset information according to an example. As shown in FIG. 8, the method includes S801-S803.

S802: minimum offset information transmitted by a user device is received. The minimum offset information is used to indicate a minimum offset between a center frequency point of an uplink interference signal and a center frequency point of an interfered signal during multicarrier transmission.

Specifically, S802 corresponds to S401 described herein, and is not described again.

S803: resource configuration information is transmitted to the user device. An offset between a first center frequency point and a second center frequency point corresponding to an uplink configuration resource indicated by the resource configuration information is greater than the minimum offset. The first center frequency point is a center frequency point of a potential uplink interference signal corresponding to the uplink configuration resource. The second center frequency point is a center frequency point of a downlink interfered signal of the potential uplink interference signal.

In some possible embodiments, the method of FIG. 8 further includes: it is determined that potential self-interference exists, a self-interference type is determined, and the uplink configuration resource is determined according to the self-interference type.

The network device determines whether potential self-interference exists during multicarrier transmission through three methods as follows.

### Method 1

Whether potential self-interference exits is determined based on TR37.863 specifications according to frequency relations between component carriers during multicarrier transmission. In a case that potential self-interference exits, an interference type of the potential self-interference is determined.

Interference center frequency ƒ_{INT} is computed according to formula (1):

$${f}_{INT} = a \times {f}_{TX 1} + b \times {f}_{RX 1} + c \times {f}_{TX 2} + d \times {f}_{RX 2} . \qquad ( 1 )$$

Coefficients a, b, c and d can be obtained according to an MSD table in sub-specification 7.3B.2.

Interference influence bandwidth BW_{INT} is computed according to formula (2):

$${BW}_{INT} = a \times {CBW}_{TX 1} + c \times {CBW}_{TX 2} . \qquad ( 2 )$$

Specifically, CBW indicates a channel bandwidth.

In a case that formula (3) is satisfied, it is determined that an uplink interference signal falls within a frequency band of received signal RX1, such that self-interference is caused.

$$\vert {f}_{INT} \vert < \frac{{BW}_{INT} + {CBW}_{RX 1}}{2} . \qquad ( 3 )$$

In a case that formula (4) is satisfied, it is determined that an uplink interference signal falls within a frequency band of received signal RX2, such that self-interference is caused.

$$\vert {f}_{INT} \vert < \frac{{BW}_{INT} + {CBW}_{RX 2}}{2} . \qquad ( 4 )$$

If it is determined from formula (3) or formula (4) that self-interference is generated, an interference type can be further determined according to the coefficient in formula (1).

In an instance, if only one of a and b is 0, the interference type is harmonic interference. Moreover, a number of times of harmonic waves is determined by a coefficient which is not zero.

If both a and b are not 0, the interference type is intermodulation interference. An order of intermodulation is a sum of an absolute value of a and an absolute value of b.

### Method 2

Whether potential self-interference of a harmonic interference type exits between component carriers during multicarrier transmission is determined according to a table on harmonic interference in Section 7.3A.4 of TS38.101 standards.

Whether potential self-interference of an intermodulation interference type exits between component carriers during multicarrier transmission is determined according to a table on intermodulation interference in Section 7.3A.5 of TS38.101 standards.

Whether potential self-interference of an adjacent channel interference type exits between component carriers during multicarrier transmission is determined according to a table on adjacent channel interference in Section 7.3A.6 of TS38.101 standards.

### Method 3

Whether potential self-interference exists between component carriers during multicarrier transmission is determined according to a self-defined table, and an interference type of the potential self-interference is determined.

In an instance, Table 2 is an illustrative table.

TABLE 2

| | | Uplink | | Downlink | | Harmonic or | Affected | |
|---|---|---|---|---|---|---|---|---|
| Multicarrier | Frequency | coefficient | | coefficient | | intermodulation | frequency | Interference |
| combination | band | a and c | | b and d | | order | band | type |
| DC_20A_n41A | 20 | a | 3 | b | 0 | 3 | n41 | Harmonic |
| | n41 | c | 0 | d | −1 | | | |
| DC_20A_n41A | 20 | a | −2 | b | −1 | 3 | 20 | Intermodulation |
| | n41 | c | 1 | d | 0 | | | |
| DC_20A_n41A | 20 | a | 4 | b | −1 | 5 | 20 | Intermodulation |
| | n41 | c | 1 | d | 0 | | | |

In some possible embodiments, the network device determines the uplink configuration resource according to the self-interference type, such that an actual offset of center frequency points of a potential uplink interference signal and a downlink interfered signal is greater than a received minimum offset transmitted by the user device.

In an instance, the network device determines an uplink bandwidth part (BWP) according to an interference type of determined potential self-interference such that an actual offset of center frequency points of a potential uplink interference signal and an interfered downlink BWP signal is greater than the received minimum offset value transmitted by the user device. As the schematic diagram shown in FIG. 9, when the uplink configuration resource is determined according to the self-interference type, the uplink configuration resource may be determined according to a computation formula corresponding to the self-interference type. The computation formula may be self-determined according to usage requirements.

In some possible implementations, the method of FIG. 8 further includes: S801 that a reporting notification message is transmitted to the user device. The reporting notification message is used to instruct the user device to report the minimum offset information.

Based on the same concept as the method examples, an example of the disclosure further provides a communication apparatus. The communication apparatus may have the function of the user device 102 in any of the method examples and may be used to execute steps executed by the user device 102 provided in any of the method examples. The function may be implemented by hardware, software or hardware executing corresponding software. The hardware or software includes one or more modules corresponding to the function.

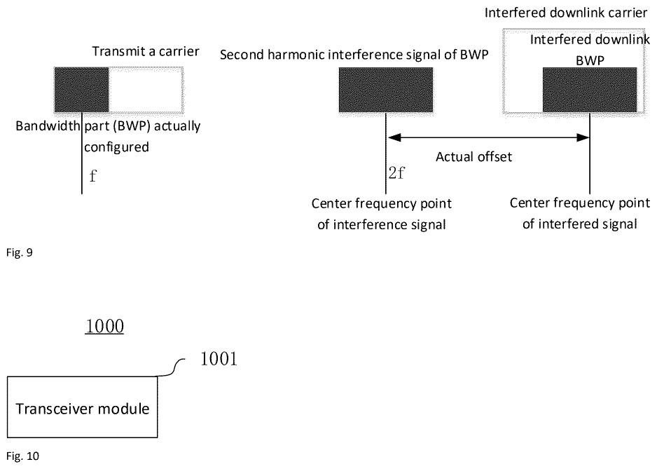

In a possible implementation, the communication apparatus may be an apparatus 1000 for transmitting interference offset information as shown in FIG. 10 and may serve as the user device 102 involved in the method examples and execute steps executed by the user device 102 in the method examples.

The apparatus 1000 includes a transceiver module 1001.

The transceiver module 1001 is configured to transmit minimum offset information to a network device. The minimum offset information is used to indicate a minimum offset between a center frequency point of an uplink interference signal and a center frequency point of an interfered signal during multicarrier transmission.

In a possible implementation, the minimum offset is a minimum offset bandwidth, or the minimum offset is a number of resource blocks corresponding to a minimum offset bandwidth.

In a possible implementation, the transceiver module 1001 is configured to receive a reporting notification message transmitted by the network device. The reporting notification message is used to instruct the reporting of the minimum offset information.

In a possible implementation, the transceiver module 1001 is configured to receive resource configuration information transmitted by the network device. An offset between a first center frequency point and a second center frequency point corresponding to an uplink configuration resource indicated by the resource configuration information is greater than the minimum offset. The first center frequency point is a center frequency point of a potential uplink interference signal corresponding to the uplink configuration resource. The second center frequency point is a center frequency point of a downlink interfered signal of the potential uplink interference signal.

In a case that the communication apparatus is a user device 102, the structure of the communication apparatus may be as shown in FIG. 11. FIG. 11 is a block diagram of an apparatus 1100 for transmitting interference offset information according to an example. For instance, the apparatus 1100 may be a mobile phone, a computer, a digital broadcasting terminal, a message transceiver device, a game console, a tablet device, a medical device, a fitness device, a personal digital assistant, etc.

With reference to FIG. 11, the apparatus 1100 may include one or more of the following components: a processing component 1102, a memory 1104, a power supply component 1106, a multi-media component 1108, an audio component 1110, an input/output (I/O) interface 1112, a sensor component 1114, and a communication component 1116.

The processing component 1102 generally controls overall operations of the apparatus 1100, such as operations associated with display, telephone call, data communication, camera operations and recording operations. The processing component 1102 may include one or more processors 1120 to execute an instruction, so as to complete all or some steps of the methods. In addition, the processing component 1102 may include one or more modules such that the processing component 1102 can interact with other components. For instance, the processing component 1102 may include a multi-media module such that the multi-media component 1108 can interact with the processing component 1102.

The memory 1104 is configured to store various types of data, so as to support operations at the apparatus 1100. Instances of such data include an instruction of any application or method used to be operated on the apparatus 1100, contact data, phonebook data, messages, pictures, video, etc. The memory 1104 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 1106 provides power for various components of the apparatus 1100. The power supply component 1106 may include a power supply management system, one or more power sources, and other components associated with generation, management and power distribution of the apparatus 1100.

The multi-media component 1108 includes a screen that provides an output interface between the apparatus 1100 and a user. In some examples, the screen may include a liquid crystal display (LCD) and a touch panel (TP). If the screen includes a touch panel, the screen can be implemented as a touch screen to receive an input signal from a user. The touch panel includes one or more touch sensors to sense a touch, a swipe and a gesture on the touch panel. The touch sensor can not only sense a boundary of a touch or a swipe, but also measure duration and pressure associated with the touch or the swipe. In some examples, the multi-media component 1108 includes a front-facing camera and/or a rear-facing camera. When the apparatus 1100 is in an operating mode, such as a photographing mode or a video mode, the front-facing camera and/or the rear-facing camera can receive external multi-media data. Each of the front-facing camera and the rear-facing camera may be a fixed optical lens system or have focusing and optical zooming capabilities.

The audio component 1110 is configured to output and/or input an audio signal. For instance, the audio component 1110 includes a microphone (MIC). When the apparatus 1100 is in an operating mode, such as a call mode, a recording mode or a voice recognition mode, the microphone is configured to receive an external audio signal. The received audio signal may be further stored in the memory 1104 or transmitted by means of the communication component 1116. In some examples, the audio component 1110 further includes a loudspeaker used to output an audio signal.

The I/O interface 1112 provides an interface between the processing component 1102 and peripheral interface modules, such as keyboards, click wheels and buttons. These buttons may include but are not limited to a home button, a volume button, a start button and a lock button.

The sensor component 1114 includes one or more sensors, which are used to provide state assessment of various aspects for the apparatus 1100. For instance, the sensor component 1114 may detect an on/off state of the apparatus 1100, and relative positioning of components, such as a display and a keypad of the apparatus 1100. The sensor component 1114 may further detect a position change of the apparatus 1100 or a component of the apparatus 1100, presence or absence of contact between a user and the apparatus 1100, orientation or acceleration/deceleration of the apparatus 1100, and a temperature change of the apparatus 1100. The sensor component 1114 may include a proximity sensor, which is configured to detect the presence of a nearby object in the absence of any physical touch. The sensor component 1114 may further include a light sensor, such as a complementary metal oxide semiconductor (CMOS) or a charge coupled device (CCD) image sensor, which are used in imaging applications. In some examples, the sensor component 1114 may further include an acceleration sensor, a gyroscopic sensor, a magnetic sensor, a pressure sensor or a temperature sensor.

The communication component 1116 is configured to facilitate wired or wireless communication between the apparatus 1100 and other devices. The apparatus 1100 may access a wireless network based on communication standards, such as Wi-Fi, 4G, 5G or their combinations. In an example, the communication component 1116 receives a broadcast signal or broadcast related information from an external broadcast management system by a broadcast channel. In an example, the communication component 1116 further includes a near-field communication (NFC) module to promote short-range communication. For instance, the NFC module may be implemented on the basis of a radio frequency identification (RFID) technology, an infrared data association (IrDA) technology, an ultra wideband (UWB) technology, a Bluetooth (BT) technology and other technologies.

In an example, the apparatus 1100 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements, and is used to execute the methods.

In an example, a non-transitory computer-readable storage medium including an instruction is further provided, such as a memory 1104 including an instruction. The instruction may be executed by the processor 1120 of the apparatus 1100 to complete the methods. For instance, the non-transitory computer-readable storage medium may be an ROM, a random access memory (RAM), a compact disc read-only memory (CD-ROM), a magnetic tape, a floppy disk or an optical data storage device, etc.

Based on the same concept as any of the method examples, an example of the disclosure further provides a communication apparatus. The communication apparatus may have the function of the network device 101 in the method examples and may be used to execute the steps executed by the network device 101 provided in the examples. The function may be implemented by hardware, software or hardware executing corresponding software. The hardware or software includes one or more modules corresponding to the function.

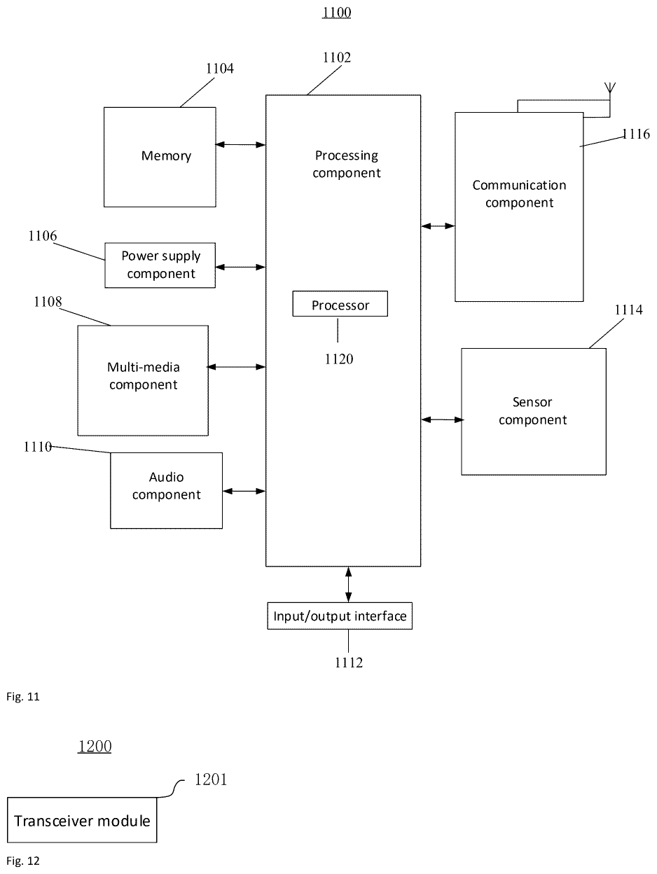

In a possible implementation, the communication apparatus may be an apparatus 1200 for transmitting interference offset information as shown in FIG. 12 and may serve as the network device 101 involved in the method examples and execute the steps executed by the network device 101 in the method examples.

The apparatus 1200 shown in FIG. 12 includes a transceiver module 1201.

The transceiver module 1201 is configured to receive minimum offset information transmitted by a user device. The minimum offset information is used to indicate a minimum offset between a center frequency point of an uplink interference signal and a center frequency point of an interfered signal during multicarrier transmission.

In a possible implementation, the minimum offset is a minimum offset bandwidth, or the minimum offset is a number of resource blocks corresponding to a minimum offset bandwidth.

In a possible implementation, the transceiver module 1201 is configured to transmit a reporting notification message to the user device. The reporting notification message is used to instruct the user device to report the minimum offset information.

In a possible implementation, the transceiver module 1201 is configured to transmit resource configuration information to the user device. An offset between a first center frequency point and a second center frequency point corresponding to an uplink configuration resource indicated by the resource configuration information is greater than the minimum offset. The first center frequency point is a center frequency point of a potential uplink interference signal corresponding to the uplink configuration resource. The second center frequency point is a center frequency point of a downlink interfered signal of the potential uplink interference signal.

In a possible implementation, the transceiver module 1201 is configured to determine that potential self-interference exists, determine a self-interference type, and determine the uplink configuration resource according to the self-interference type.

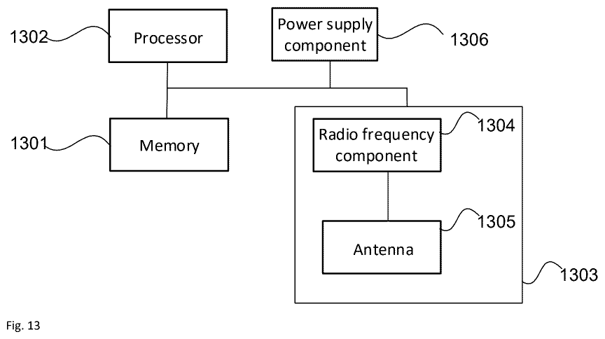

In a case that the communication apparatus is a network device 101, the structure of the communication apparatus may be as shown in FIG. 13. As shown in FIG. 13, the apparatus 1300 includes a memory 1301, a processor 1302, a transceiver component 1303, and a power supply component 1306. The memory 1301 is coupled to the processor 1302 and may be used to store a program and data necessary for the apparatus 1300 to implement various functions. The processor 1302 is configured to support the apparatus 1300 in executing a corresponding function in the methods. The function may be implemented by calling a program stored in the memory 1301. The transceiver component 1303 may be a wireless transceiver, and may be used to support the apparatus 1300 in receiving a signaling and/or data and transmitting a signaling and/or data through radio. The transceiver component 1303 may also be referred to as a transceiver unit or a communication unit. The transceiver component 1303 may include a radio frequency component 1304 and one or more antennas 1305. The radio frequency component 1304 may be a remote radio unit (RRU), and may be used for transmission of radio frequency signals and conversion between radio frequency signals and baseband signals. The one or more antennas 1305 may be specifically used to radiate and receive radio frequency signals.

When the apparatus 1300 is required to transmit data, the processor 1302 may carry out baseband processing on the data to be transmitted and output a baseband signal to the radio frequency component 1304. The radio frequency component 1304 may carry out radio frequency processing on the baseband signal and transmit the radio frequency signal in the form of an electromagnetic wave by means of an antenna. When data is transmitted to the apparatus 1300, the radio frequency component 1304 receives a radio frequency signal by means of the antenna, converts the radio frequency signal into a baseband signal, and outputs the baseband signal to the processor 1302. The processor 1302 converts the baseband signal into data and processes the data.

Those skilled in the art could easily conceive of other implementation solutions of examples of the disclosure upon consideration of the description and the invention disclosed in the implementation. The disclosure is intended to cover any variations, uses or adaptive changes of examples of the disclosure, which follow the general principles of examples of the disclosure and include common general knowledge or customary technical means in the art which is not disclosed in the disclosure. The description and examples are regarded as illustrative merely. The true scope and spirit of the disclosure are indicated by the following claims.

It should be understood that examples of the disclosure are not limited to a precise structure described and shown in accompanying drawings, and can have various modifications and changes without departing from the scope of the disclosure. The scope of examples of the disclosure is limited by the appended claims merely.

### INDUSTRIAL APPLICABILITY

A user device transmits, to a network device, minimum offset information indicating a minimum offset between a center frequency point of an uplink interference signal and a center frequency point of an interfered signal during multicarrier transmission. The network device can determine more reasonable resource configuration information according to the received minimum offset information, and configure, for the user device, an uplink configuration resource capable of preventing self-interference such that self-interference during multicarrier transmission can be reduced and a performance of the multicarrier transmission can be improved.

1. A method for transmitting interference offset information, performed by a user device, comprising:
transmitting minimum offset information to a network device, wherein the minimum offset information is used to indicate a minimum offset between a center frequency point of an uplink interference signal and a center frequency point of an interfered signal during multicarrier transmission.

2. The method according to claim 1, further comprising:
receiving a reporting notification message transmitted by the network device, wherein the reporting notification message is used to instruct the reporting of the minimum offset information.

3. The method according to claim 1, wherein the minimum offset information comprises the minimum offset corresponding to at least one self-interference type.

4. The method according to claim 1, wherein the minimum offset is a minimum offset bandwidth.

5. The method according to claim 1, further comprising:
receiving resource configuration information transmitted by the network device, wherein
an offset between a first center frequency point and a second center frequency point corresponding to an uplink configuration resource indicated by the resource configuration information is greater than the minimum offset,
the first center frequency point is a center frequency point of a potential uplink interference signal corresponding to the uplink configuration resource, and
the second center frequency point is a center frequency point of a downlink interfered signal of the potential uplink interference signal.

6. A method for transmitting interference offset information, performed by a network device, comprising:
receiving minimum offset information transmitted by a user device, wherein the minimum offset information is used to indicate a minimum offset between a center frequency point of an uplink interference signal and a center frequency point of an interfered signal during multicarrier transmission.

7. The method according to claim 6, further comprising:
transmitting a reporting notification message to the user device, wherein the reporting notification message is used to instruct the user device to report the minimum offset information.

8. The method according to claim 6, wherein the minimum offset information comprises the minimum offset corresponding to at least one self-interference type.

9. The method according to claim 6, wherein the minimum offset is a minimum offset bandwidth, or the minimum offset is a number of resource blocks corresponding to a minimum offset bandwidth.

10. The method according to claim 6, further comprising:
transmitting resource configuration information to the user device, wherein
an offset between a first center frequency point and a second center frequency point corresponding to an uplink configuration resource indicated by the resource configuration information is greater than the minimum offset,
the first center frequency point is a center frequency point of a potential uplink interference signal corresponding to the uplink configuration resource, and
the second center frequency point is a center frequency point of a downlink interfered signal of the potential uplink interference signal.

11. The method according to claim 10, further comprising:
determining that potential self-interference exists;
determining a self-interference type; and
determining the uplink configuration resource according to the self-interference type.

12-13. (canceled)

14. A communication apparatus, comprising one or more processors and a memory, wherein
the memory is used to store a computer program; and
the one or more processors are collectively configured to:
transmit minimum offset information to a network device, wherein the minimum offset information is used to indicate a minimum offset between a center frequency point of an uplink interference signal and a center frequency point of an interfered signal during multicarrier transmission.

15. A communication apparatus, comprising one or more processors and a memory, wherein
the memory is used to store a computer program; and
the one or more processors are collectively configured to execute the computer program, so as to implement the method according to claim 6.

16. A non-transitory computer-readable storage medium, storing one or more programs configured to be executed by one or more processors of a computer, the one or more programs comprising instructions, which when executed by the computer, the computer is caused to execute the method according to claim 1.

17. A non-transitory computer-readable storage medium, storing one or more programs configured to be executed by one or more processors of a computer, the one or more programs comprising instructions, which when executed by the computer, the computer is caused to execute the method according to claim 6.

18. The communication apparatus according to claim 14, wherein the one or more processors are collectively configured to:
receive a reporting notification message transmitted by the network device, wherein the reporting notification message is used to instruct the reporting of the minimum offset information.

19. The communication apparatus according to claim 14, wherein the minimum offset information comprises the minimum offset corresponding to at least one self-interference type.

20. The communication apparatus according to claim 14, wherein the minimum offset is a minimum offset bandwidth, or the minimum offset is a number of resource blocks corresponding to a minimum offset bandwidth.

21. The communication apparatus according to claim 14, wherein the one or more processors are collectively configured to:
receive resource configuration information transmitted by the network device, wherein
an offset between a first center frequency point and a second center frequency point corresponding to an uplink configuration resource indicated by the resource configuration information is greater than the minimum offset,
the first center frequency point is a center frequency point of a potential uplink interference signal corresponding to the uplink configuration resource, and
the second center frequency point is a center frequency point of a downlink interfered signal of the potential uplink interference signal.

22. The method according to claim 1, wherein the minimum offset is a number of resource blocks corresponding to a minimum offset bandwidth.
